(19) United States
(12) Patent Application Publication
(10) Pub. No.: US 2007/0156992 A1
(43) Pub. Date: Jul. 5, 2007

(54) Method and system for optimizing latency of dynamic memory sizing

(75) Inventor: Sanjeev Jahagirdar, Folsom, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/323,259

(22) Filed: Dec. 30, 2005

(51) Int. Cl. G06F 13/00; G06F 13/28

(52) U.S. Cl. 711/167; 711/144

(57) ABSTRACT

Some embodiments of the invention include a system and method for optimizing the latency of dynamic memory sizing. In some embodiments, the operating requirements can reflect amount of memory required to perform commensurate operations. Memory power management logic is used to coordinate memory requirements with operating requirements. The latency of changes to the memory based on operating requirements is optimized by the method and system. Other embodiments are described.

### CROSS-REFERENCE TO RELATED APPLICATIONS

This application is related to U.S. application Ser. No. 10/931,565 filed Aug. 31, 2004 by inventors Kurts et al., assigned to Intel Corporation; U.S. application Ser. No. 10/934,034 filed Sep. 3, 2004 by inventors Naveh et al. assigned to Intel Corporation; U.S. application Ser. No. 11/024,538 filed Dec. 28, 2004 by inventors Naveh et al. assigned to Intel. Corporation; U.S. application Ser. No. 10/899,674 filed Jul. 27, 2004 by inventors Naveh et al. assigned to Intel Corporation; and to concurrently filed patent application entitled “Method and Apparatus for a Zero Voltage Sleep State” by inventor Jahagirdar, assigned to Intel Corporation, Docket Number 042390.P22435.

### BACKGROUND

1. Technical Field

Some embodiments of the invention generally relate to integrated circuits and/or computing systems. More particularly, some embodiments of the invention relate to dynamic memory sizing.

2. Discussion

As the trend toward advanced microprocessors, e.g. central processing units (CPUs), with more transistors and higher frequencies continues to grow, computer designers and manufacturers are often faced with corresponding increases in power and energy consumption. Particularly in mobile devices, increased power consumption can lead to overheating, which may negatively affect performance, and can significantly reduce battery life. Because batteries typically have a limited capacity, running the processor of a mobile device more than necessary could drain the capacity more quickly than desired.

Thus, power consumption continues to be an important issue for computing systems, including desktop computers, laptop computers, wireless handsets, personal digital assistants, etc. In today's computing systems, for example, to address power dissipation concerns, certain components may be placed into lower power states based on reduced activity or demand.

Developing simultaneously in microprocessor design, memory sizes are increasing to achieve better performance for a given silicon area. The trend toward larger memory sizes has increased the portion of power consumption associated with memories. As a result, the application of lower power states and latencies associated with operating larger memories entering and exiting these states has become an increasingly significant area for the management of power consumption.

### BRIEF DESCRIPTION OF THE DRAWINGS

Various advantages of embodiments of the present invention will become apparent to one skilled in the art by reading the following specification and appended claims, and by referencing the following drawings, in which:

FIG. 1 is a block diagram of an example of a memory architecture organized by ways according to some embodiments of the invention;

FIG. 2 is a block diagram of another example of a memory architecture not organized by ways according to some embodiments of the invention;

FIGS. 3-4 is a diagram of a bit-level example of warm and dirty bits according to some embodiments of the invention;

FIG. 5 is a diagram of an example of logic to generate warm and dirty bits according to some embodiments of the invention;

FIG. 6 is a block diagram of an example computer system that may be utilized to implement the optimization of memory latency with dynamic memory sizing according to embodiments of the invention;

FIG. 7 is a flowchart of an example of a process of optimizing memory latency according to some embodiments of the invention;

FIG. 8 is a flowchart of an example of a process for memory exit, which may include dynamic memory reduction or low power state entry flow, according to some embodiments of the invention; and

FIG. 9 is a flowchart of an example of a process for memory entry, which may include dynamic memory expansion or low power state exit flow, according to some embodiments of the invention.

### DETAILED DESCRIPTION

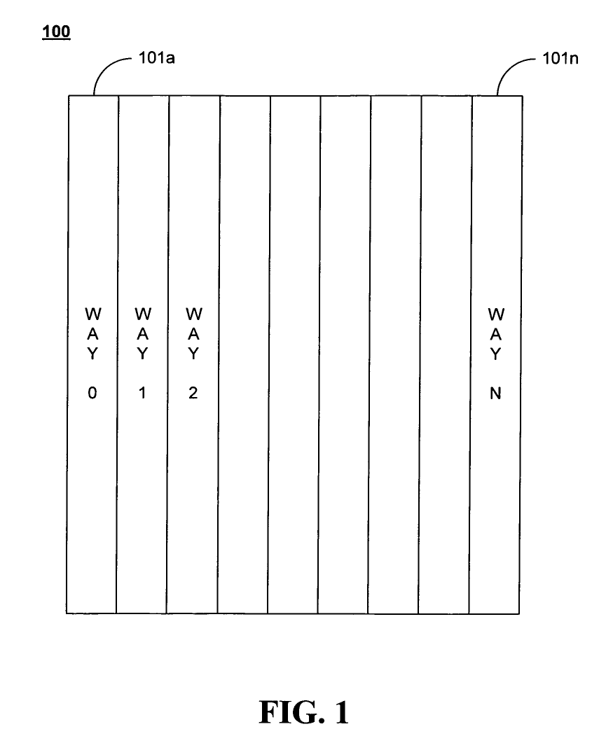

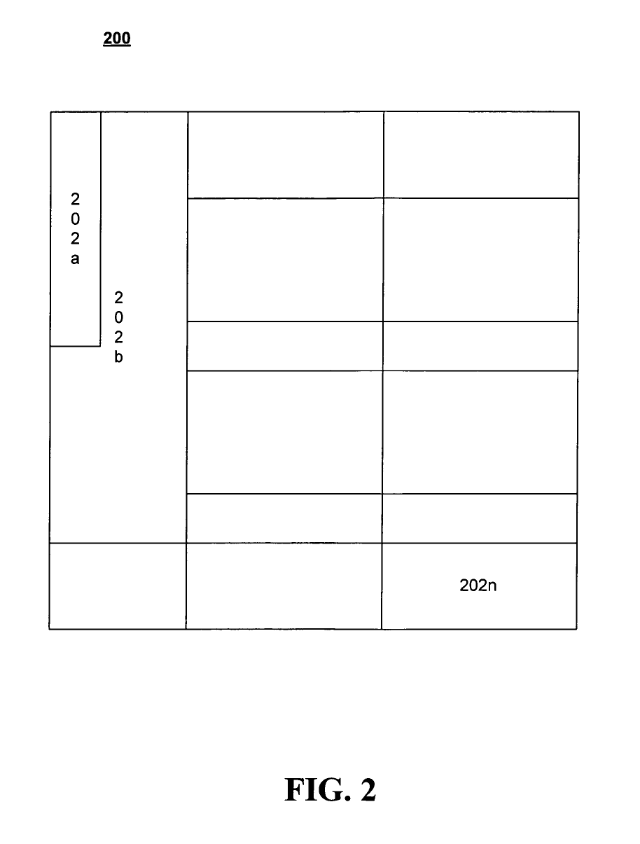

The amount of memory that may actually be required by a computing system and/or its associated software often varies with respect to time. For typical applications, for example, only a small portion of the memory may be needed at any given time. According to some embodiments of the invention, a memory arrangement, such as the memory arrangements of FIGS. 1 and 2, may be dynamically sized to reduce the power requirements of a memory circuit and the system in which it is used.

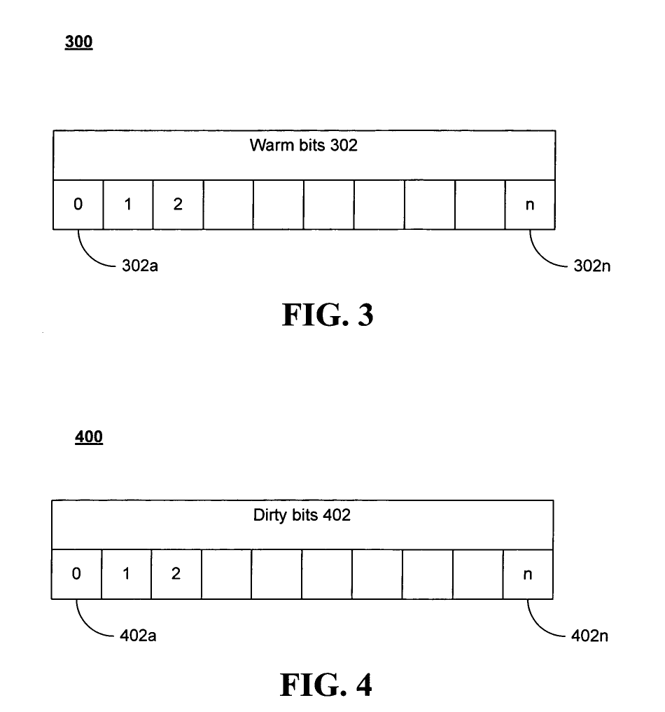

Specifically, as is described herein, some embodiments of the invention may provide optimized latency during an enabling/disabling of one or more sub-sections of a memory when those sub-sections are not needed and/or are unselected, as is described with respect to FIGS. 3-9 implemented with the memory topologies shown in FIGS. 1-2. In some embodiments of the invention, the memory may be enabled/disabled in specific states of the computing system. The states, also called power states, are discussed in additional detail below with respect to the states discussed by Advanced Configuration and Power Interface (ACPI). specification (for example, ACPI Specification, Rev. 3.0, Sep. 2, 2004; Rev. 2.0c, Aug. 25, 2003; Rev. 2.0, Jul. 27, 2000, etc.).

FIG. 1 shows a block diagram of an example of a memory architecture organized by ways according to some embodiments of the invention. In some embodiments with dynamically sizable memory the n-way associative memory of FIG. 1 may be implemented, for example, using static random access memory (SRAM). The plurality of sub-sections 101a, 101b-101n (each of which are ways in this particular example), may be separately or jointly coupled to a plurality of sleep devices (not shown), such that each of the sub-sections or ways 101 may be selectively enabled/disabled, or equivalently and. selectively coupled/decoupled from a power source.

Alternative sleep devices may be used and those devices discussed are illustrative of the types of sleep devices which may be employed by one of ordinary skill in the art, based at least on the teachings provided herein, according to some embodiments of the invention. The use of the terms ‘power gating transistor’, ‘sleep transistor’ and ‘sleep device’ are not intended to limit the scope of the invention to any specific devices, rather they are merely intended to describe the sleep devices ability to turn off or gate power to the memory subsection. Moreover, as may be apparent to one of ordinary skill, these various embodiments of sleep devices may have applications which are more specialized than others and may be more advantageous, therefore, for certain types of dynamically sizable memory.

The memory topology may determine whether specific sleep devices may be used to control power to a section or sub-section of the memory. With respect to FIG. 1, in some embodiments, where the memory is organized by ways, then sleep devices may be used to control each way of the memory. If the memory topology is organized in some other manner, especially where a given way may not be isolated, then sleep devices may not be able to control certain sections of the memory. Alternative means are discussed with respect to FIG. 2.

FIG. 2 shows a block diagram of another example of a memory architecture not organized by ways according to some embodiments of the invention. Ways 202a, 202b-202n are of arbitrary size and arbitrarily placed in the memory. In some embodiments of the invention, where the ways are physically distributed over different blocks of the memory, the memory may be flushed by ways in a progressive manner, but the ways can not be powered off using sleep devices. As such, the memory may only be powered off using sleep transistors after all of the ways for a given block are flushed.

According to some embodiments of the invention, one or more ways, such as, but not limited to those shown in FIGS. 1 and 2, may be reduced using a way-based dynamic sizing process. In some embodiments of the invention, various dynamic sizing processes may be implemented upon entry and/or exit from various power states by the components of the computing system.

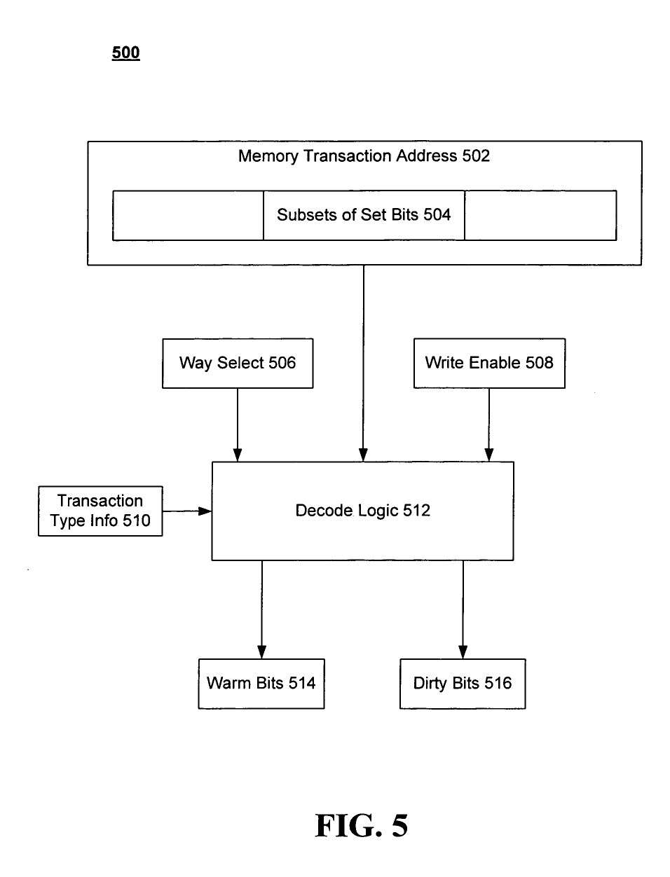

With respect to memory accessed by a processor (e.g., a multiple core processor or central processing unit (CPU), a processor's microcode (see FIG. 5 below) may walk through lines in each way to flush any modified data in the way(s) being deactivated or shrunk, according to some embodiments of the invention. In some embodiments of the invention, after all the modified data is flushed to memory, the power to the way(s) may be turned off using, e.g., sleep devices.

In accordance with some embodiments of the invention, power management logic (PML) of the processor or control logic of the backside bus logic (BBL) (see FIG. 5 below), may stop allocating to the deactivated ways by way of least recently used (LRU). In further embodiments of the invention, when a way is re-enable, reactivated (or in other words, when the memory is grown, as opposed to the above ‘shrinking’), the power gating transistors may be turned on; the state bits of the ways cleared (e.g., state I of a. MESI protocol); and the PML or control logic may start allocating to this way. It is noted that alternative coherency or write-invalidate protocols other than MESI (4-states: modified, exclusive, shared, invalid) may be implemented and used by the invention, as one of ordinary skill would recognize. For example, one or ordinary skill would find it readily apparent that either MOESI (5-states: modified, owner, exclusive, shared, invalid) or DRAGON (4-states: valid-exclusive, shared-clean, shared-modified, dirty) may be implemented. According to some embodiments of the invention, such as, but not limited to, embodiments using a state with zero voltage, the state bits may be retained. If the state bits are retained, then, in some embodiments of the invention, the PML 150 or power management state control logic 642 may not clear them when exiting from a power state.

For some embodiments of the invention, various circuit techniques may be used to implement alternative sleep logic and/or to provide functionality similar to the sleep devices yet using a different approach. In some embodiments of the invention, for example, different sub-sections of a memory may be implemented on different power planes such that sub-sections of the memory may be enabled/disabled through power plane control. Other approaches are within the scope of various embodiments.

Further, while an n-way associative memory implemented on a microprocessor is described herein for purposes of illustration, it will be appreciated that embodiments of the invention may be applied to other types of memory, including memories having a different architecture and/or memories implemented on another type of integrated circuit device. Furthermore, in some embodiments of the invention, the term “memory,” “cache,” and “cache memory” are used, but this is not mean to restrict the operation of embodiments of the invention as it is applicable to all forms or types of memories, especially, in some embodiments, cache memory.

For some embodiments of the invention, for example, other partitions, sub-sections or portions of memory, including cache memories of various levels, may be selectively enabled and/or disabled using one or more of the approaches described herein. The illustrated ways may therefore provide a convenient grouping of cells, such as an array, but use of the term ‘ways’ is not intended to limit the spirit or scope of the invention.

In some embodiments of the invention, the active ways may be flushed in a progressive manner. One of ordinary skill in the relevant art(s) would appreciated, based at least on the teachings described herein, other manners of flushing ways of the cache. The time required to flush the cache is one factor that determines the latency of entry to a power state, such as, but not limited to a sleep state. On exit from a power state, such as, but not limited to a sleep state, the cache state bits are, among other things, invalidated. The time required to invalidate the state bits is one factor that determines the latency of exit from the power state.

According to some embodiments of the invention, the optimization or improvement, such as by reducing the amount of time required, to enter and exit power states may be extremely useful for manufacturers, users and programmers. Some embodiments of the invention may be applied to the cache topologies described above in FIGS. 1 and 2, as well as other topologies, such as, but not limited to, cache topologies that include blocks which are instantiated multiple times to implement the cache. Furthermore, in some embodiments of the invention, the ways of the cache(s) may be uniform by ways or non-uniform by sets and ways, and may be mapped in various manners, as one of ordinary skill in the art would appreciate based at least on the teachings described herein.

In some embodiments of the invention, the power states may employ a line-by-line cache flush micro-architecture, where the processor(s) may check each line in the cache to see if they contain modified data. to be written to the main memory. Thus, according to some embodiments of the invention, the process of tracking cache data, e.g., modified data, may reduce the entry and exit latencies. The reduction in latency may help in at least two manners. First, there may be an improvement in entry/exit performance. Second, there may be a savings in the energy required to operate the cache(s) because some flushing/invalidating of lines of the cache(s) may not occur.

According to some embodiments of the invention, the tracking of the cache states may be aided by the use of warm bits and/or dirty bits. Warm bits, in some embodiments of the invention, may be used to record whether a particular cache block has been accessed since the last exit from a power state. In some embodiments of the invention, the accessing may include a read and/or write operation to any line of that cache block. Dirty bits, in some embodiments of the invention, may be used to record whether a particular cache block includes modified data. In some embodiments of the invention, the modified data may be detected by observing the state information of the write operations which occur for lines in the cache block.

FIGS. 3 and 4 illustrate some embodiments of the warm and dirty bits, respectively, where there may be one bit per block. Other embodiments may be employed without deviating from the teachings described herein. In FIG. 3, warm bits 302 are shown in a row 302a, 302b-302n. In FIG. 4, dirty bits 402 are shown in a row 402a, 402b-402n. In some embodiments of the invention, the dirty. bits may be a subset of the warm bits. As such, in some embodiments, a particular cache block may be dirty only if it is also warm, i.e., access or use may be a prerequisite for modification in some embodiments of the invention.

According to one or more embodiments, to enable and/or disable associated sub-sections of the dynamically sizable memory 101 and/or 202, the logic required to control the optimization process may be implemented in a host integrated circuit, a computer system or in software. Examples of such an implementation are described herein with respect to some embodiments of the invention.

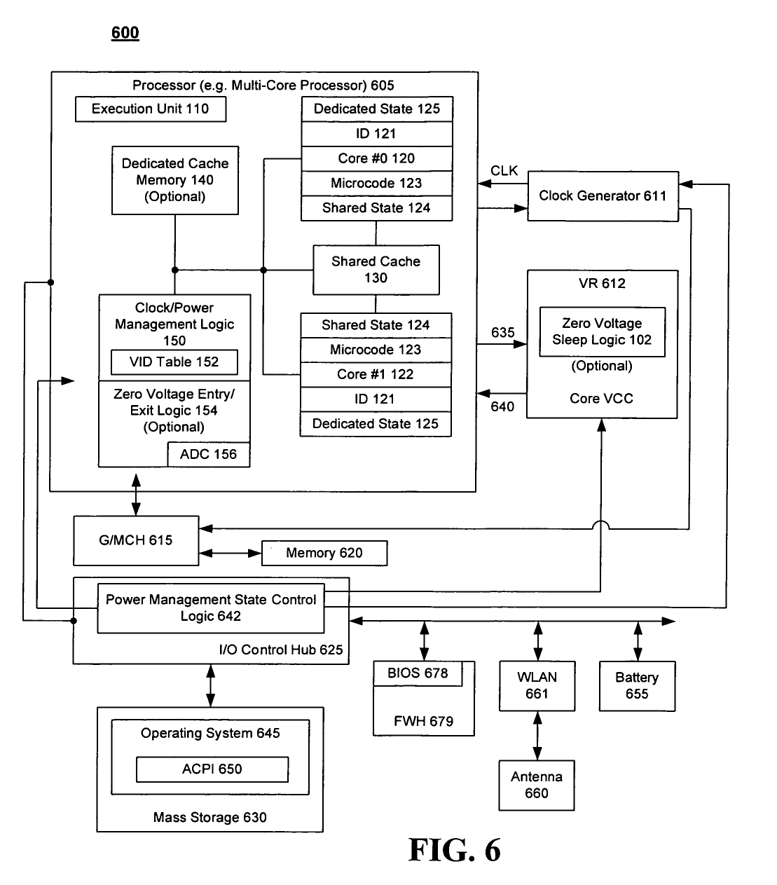

FIG. 5 is a diagram of an example of logic to generate warm and dirty bits according to some embodiments of the invention. The logic may be implemented in hardware, software or firmware, according to some embodiments of the invention, and may be stored and/or operated from the PML 150, the power management state control logic 642 or the operating system (OS) 645, all shown in FIG. 6, which is described below.

According to some embodiments of the invention, this logic generates warm and/or dirty bits based on one or more of the following: addresses of one or more transactions to the cache, one or more read/write enables, and state/way information. In some embodiments of the invention, logic 500 includes decode logic 512 which receives memory transaction information 502, as well as way select 506 and way enable 508 information. In some embodiments of the invention, the memory transaction address 502 may include one or more subsets of set bits 504.

In accordance with some embodiments of the invention, the decode logic 512 may also receive transaction type information 510. In some embodiments, examples of transaction types may include: memory read, memory write, memory probe, memory write-back (flush), or memory invalidate. The memory attributes (e.g., using MESI) may also be read by 510. This information may be used to generate of warm bits and/or dirty bits because the bits may be set to 1 only on types of memory transaction, according to some embodiments of the invention. For example, in some embodiments, the warm bit may be set on any transaction to that set and way. Furthermore, in some embodiments, the dirty bit may be set if modified data. is written to that set and way. In some embodiments of the invention, the decode logic 512 is then able to generate one or more warm bit 514 and/or one or more dirty bits 516. In some embodiments the decode logic may be aware of the memory topology and the block boundaries.

Furthermore, in some embodiments of the invention, the decode logic may clear the warm bits 514 and dirty bits 516. In alternative embodiments, the PML 150, the power management state control logic 642 or the OS 645 may clear the bits 514 and/or 516. In some embodiments, the dirty bits 516 may be cleared when the block of memory is flushed. In some embodiments, the warm bits 514 may be cleared when exiting a power state.

In some embodiments of the invention, whenever a power state is exited, the warm and dirty bit information collection process may be restarted. In these embodiments, the warm and dirty bits may be saturating in nature, i.e., the warm bit may be 1 (of either 1 or 0) for multiple writes to the same block of memory. In some embodiments of the invention, the bits 514 and 516 may be cleared only on explicit resets of a computing system. In some embodiments, multiple memory blocks may share warm bits and/or dirty bits.

As described elsewhere herein, some embodiments of the invention may be implemented in one or a combination of hardware, firmware, and software. Some embodiments of the invention may also be implemented in whole or in part as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

FIG. 6 is a block diagram of an example computer system that may be utilized to implement the optimization of memory latency with dynamic memory sizing according to embodiments of the invention. The system 600 may be a notebook or laptop computer system, or may be any different type of mobile electronic system such as a mobile device, personal digital assistant, wireless telephone/handset or may even be a non-mobile system such as a desktop or enterprise computing system. Other types of electronic systems are also within the scope of various embodiments.

The system 600 includes a processor 605, e.g., a multi-core processor, a platform-level clock generator 611, a voltage regulator 612 coupled to the processor 605, a memory control hub 615 coupled to the processor 605 over a bus 617, a memory 620 which may comprise one or more of random access memory (RAM), flash memory and/or another type of memory, an input/output (I/O) control hub 625 coupled to the memory control hub 615 over a bus 627, and a mass storage device 630 coupled to the I/O control hub 625 over a bus 632. Although, system 600, in some embodiments, may be a mobile device with the subsystems described, it should be appreciated that system 600 may be a different type of mobile device or a non-mobile device, with more or less than the subsystems described.

In some embodiments of the invention, the processor 605 may be an Intel® architecture microprocessor such as, for example, a follow-on processor to the Intel Pentium® M processor including one or more processing cores (e.g. 120 and 122) and at least one execution unit 110 to process instructions. For some embodiments of the invention, the processor 605 may include Intel SpeedStep® technology or another power management-related technology that provides for two or more voltage/frequency operating points. An associated clock/power management unit 150 may be included in the processor 605 to control transitions between two or more of the voltage/frequency pairs.

In some embodiments of the invention, the processor 605 may be a different type of processor such as a digital signal processor, an embedded processor, or a microprocessor from a different source.

Optionally, processor 605 may include a dedicated cache memory 140 (e.g. synchronous random access memory (SRAM)) that may be used to store the processor's state variables and warm/dirty bit information. In some embodiments of the invention, the memory 140 may store some or all of this information when the processor enters a very low voltage state, such as, but not limited to the zero-voltage sleep state. In some embodiments of the invention, memories may be built into the processor's chip or packaged within the same housing as the processor chip.

Where Intel SpeedStep® technology or another type of power management technology is included on the processor 605, the available voltage/frequency pairs associated with the technology include a minimum voltage/frequency pair corresponding to a minimum active mode operating voltage and a minimum operating frequency associated with the processor 605 for a fully functional operational mode. These may be referred to herein as the minimum operating voltage and minimum operating frequency or minimum active mode operating voltage and frequency, respectively. Similarly, a maximum operating voltage and frequency may be defined. Other available voltage frequency pairs may be referred to as operating voltage/frequency pairs or simply other voltage/frequency or frequency/voltage pairs.

Optionally, zero voltage entry/exit logic 154 may also be included in processor 605, either within or outside of the power management logic (PML) 150, to control entry into and exit from the zero voltage sleep state, also referred to herein as the C6 state. As is described elsewhere herein, the PML 150 may include the logic 500.

A voltage identification (VID) memory 152 that is accessible by the zero voltage entry/exit logic 154 may be included to store a voltage identification code look-up table. The VID memory may be an on-chip or off-chip register or another type of memory, and the VID data may be loaded into the memory via software, basic input/output system (BIOS) code 678 (which may be stored on a firmware hub 679 or in another memory), an operating system, other firmware and/or may be hardcoded, for example. Alternatively, a software look-up table including VID and related data may be otherwise accessible by the logic 150. The VID information may also be stored on the CPU as fuses (e.g., programmable ROMs (PROMs)).

In some embodiments of the invention, the information required for the operation of the logic 500 and/or the status of the warm/dirty bits may be similarly stored along with the VID data.

An analog-to-digital converter (ADC) 156 may also be provided as part of the zero voltage entry/exit logic 150 to monitor a voltage supply level and provide an associated digital output as described in more detail below.

Voltage regulator 612 provides a supply operating voltage to the processor 605 and may be in accordance with a version of the Intel Mobile Voltage Positioning (IMVP) specification such as the IMVP-6 specification, for example. For such embodiments, the voltage regulator 612 is coupled to receive VID signals from the processor 605 over a bus 635 and, responsive to the VID signals, provides an associated operating voltage to the processor 605 over a signal line 640. The voltage regulator 612 may include zero voltage sleep logic 102 that is responsive to one or more signals to reduce voltage 640 to the processor 605 to a zero state and then ramp the voltage to the processor back up again after exiting the zero voltage sleep state.

For other embodiments of the invention, a different type of voltage regulator may be used, including a voltage regulator in accordance with a different specification. Further, for some embodiments, the voltage regulator may be integrated with another component of the system 600 including the processor 605. It should be appreciated that the voltage regulator may or may not be integrated with the CPU dependent upon design considerations.

The memory control hub 615 may include both graphics and memory control capabilities and may alternatively be referred to herein as a graphics and memory control hub (G/MCH) or a North bridge. The graphics and memory control hub 615 and the I/O control hub 625 (which also may be referred to as a South bridge) may be collectively referred to as the chipset. For other embodiments, chipset features may be partitioned in a different manner and/or may be implemented using a different number of integrated circuit chips. For example, for some embodiments, graphics and memory control capabilities may be provided using separate integrated circuit devices.

The I/O control hub 625 of some embodiments includes power management state control logic 642, alternatively referred to herein as C-state control logic. The power management state control logic 642 may control aspects of the transitions between some power management and/or normal operational states associated with the processor 605, either autonomously or in response to operating system or other software or hardware events. For example, for Intel® architecture processors for which at least active mode and power management states referred to as C0, C1, C2 and C4, C5 and C6 are supported, the power management state control logic 642 may at least partially control transitions between at least a subset of these states using one or more of a stop clock (STPCLK#), processor sleep (SLP#), deep sleep (DPSLP#), deeper stop (DPRSTP#), and/or stop processor (STPCPU#) signals.

Also, in some embodiments of the invention, voltage from the I/O control hub 625 (VI/O 149) may be provided to the processor 605 in order to provide sufficient power to the dedicated cache memory 140 such that it can store the state variables associated with the processor 605 while the rest of the processor 605 is powered down by the reduction of the operating voltage 640 down to a zero state. In some embodiments of the invention, the state variables include warm bit and/or dirty bit information.

For other types of architectures and/or for processors that support different power management and/or normal operational states, the power management state control logic 642 may control transitions between two or more different power management and/or normal operational states using one or more signals that may be similar to or different from the signals described herein.

The mass storage device 630 may include one or more compact disc read-only memory (CD-ROM) drive(s) and associated disc(s), one or more hard drive(s) and associated disk(s) and/or one or more mass storage devices accessible by the computing system 600 over a network. Other types of mass storage devices such as, for example, optical drives and associated media, are within the scope of various embodiments.

For some embodiments, the mass storage device 630 stores an operating system 645 that includes code 650 to support a current and/or a follow-on version of the ACPI specification, which is discussed elsewhere herein. ACPI may be used to control some aspects of power management as described in more detail below. The operating system 645 may be a Windows™ or another type of operating system available from Microsoft®. Corporation of Redmond, Wash. Alternatively, a different type of operating system such as, for example, a Linux™ operating system, and/or a different type of operating system-based power management may be used for other embodiments. Further, the power management functions and capabilities described herein as being associated with ACPI may be provided by different software or hardware.

Also, it should be appreciated that system 600 may include a display device, such as a cathode ray tube (CRT) or liquid crystal display (LCD), for displaying information to a user. Further, system 600 may include an alphanumeric input device (e.g., a keyboard), including alphanumeric and other keys, for communicating information and command selections to processor 605. An additional user input device may be cursor control device, such as a mouse, trackball, trackpad, stylus, or cursor direction keys, for communicating direction information and command selections to processor 605, and for controlling cursor movement on the display device.

Another device that may included with system is a hard copy device, which may be used for printing instructions, data, or other information on a medium such as paper, film, or similar types of media. Furthermore, a sound recording and playback device, such as a speaker and/or microphone (not shown) may optionally be included in system 600 for audio interfacing.

Where the system 600 is a mobile or portable system, a battery or battery connector 655 may be included to provide power to operate the system 600 either exclusively or in the absence of another type of power source. Additionally, for some embodiments, an antenna 660 may be included and coupled to the system 600 via, for example, a wireless local area network (WLAN) device 661 to provide for wireless connectivity for the system 600.

WLAN device 661 may include a wireless communication module that may employ a Wireless Application Protocol (WAP) to establish a wireless communication channel. The wireless communication module may implement a wireless networking standard such as Institute of Electrical and Electronics Engineers (IEEE) 802.11 standard, IEEE std. 802.11-1999, published 1999.

It should be appreciated that, in some embodiments of the invention, the processor 605 of FIG. 6 may transition between various known C-states. The normal operational state or active mode for the processor 605 is the C0 state in which the processor actively processes instructions. In the C0 state, the processor 605 is in a high-frequency mode (HFM) in which the voltage/frequency setting may be provided by the maximum voltage/frequency pair.

In order to conserve power and/or reduce thermal load, for example, the processor 605 may be transitioned to a lower power state whenever possible. For example, from the C0 state, in response to firmware, such as microcode, or software, such as the operating system 645, or even ACPI software in some cases, executing a HALT or MWAIT instruction (not shown), the processor 605 may transition to the Cl or Auto-HALT state. In the C1 state, portions of the processor 605 circuitry may be powered down and local clocks may be gated.

The processor may transition into the C2 state, also referred to as the stop grant or SLEEP state, upon assertion of the STPCLK# or similar signal by the I/O controller 625, for example. The I/O controller 625. may assert the STPCLK# signal in response to the operating system 645 determining that a lower power mode may be or should be entered and indicating this via ACPI software 650. In particular, one or more ACPI registers (not shown) may be included in the I/O controller 625 and the ACPI software 650 may write to these registers to control at least some transitions between states. During operation in the C2 state, portions of the processor 605 circuitry may be powered down and internal and external core clocks may be gated. For some embodiments, the processor may transition directly from the C0 state into the C2 state.

Similarly, the processor 605 may transition into the C3 state, also referred to as the Deep Sleep state, in response to the I/O controller 625 or other chipset feature asserting a CPUSLP# signal and then a DPSLP# signal or other similar signals. In the Deep Sleep state, in addition to powering down internal processor circuitry, all phase-lock loops (PLLs) in the processor 605 may be disabled. Further, for some embodiments, a STOP_CPU signal may be asserted by the input/output controller 625. and received by the clock generator 611 to cause the clock generator to halt the clock signal CLK to the CPU 605.

In the system 600, a transition into the C4 state or into a zero voltage sleep state may be undertaken in response to ACPI software 650 detecting that there are no pending processor interrupts, for example. ACPI software may do this by causing the ICH 625 to assert one or more power management-related signals such as the exemplary Deeper Stop (DPRSTP#) signal and the exemplary DPSLP# signal. The Deeper Stop (DPRSTP#) signal is provided directly from the chipset to the processor and causes clock/power management logic 650 on the processor to initiate a low frequency mode (LFM). For the low frequency mode, the processor may transition to the minimum or another low operating frequency, for example.

According to some embodiments of the invention, assertion of the DPRSTP# signal may further cause the internal VID target to be set to a zero voltage level, resulting in a zero operational voltage being applied to the processor 605. by the voltage regulator 612, such that the processor transitions into a very deep sleep state that has very low power consumption characteristics.

According to some embodiments of the invention, an integrated circuit such as processor 605, for example, may initiate a transition to a zero voltage power management state. In one example, processor 605. may be a central processing unit (CPU) 605. Further, the zero voltage management state may be, for example, a deeper sleep state in accordance with ACPI standards. During this transition, the state of the CPU 605 may be saved. For example, state variables associated with the CPU 605 may be saved in dedicated cache memory (e.g. SRAM) 140.

The operating voltage of the CPU 605 may be subsequently reduced to zero such that the CPU 605 is in a very deep sleep state that has very low power consumption characteristics. Particularly, the voltage regulator 612 utilizing optional zero voltage sleep state logic 102 may reduce the operating voltage 640 down to zero. As previously discussed, this may be done in conjunction with zero voltage entry/exit logic 154 of clock/power management logic 150 of CPU 605. In some embodiments, this zero voltage power management state, when implemented in conjunction with ACPI standards, may be referred to as the C6 state.

Subsequently, in response to receiving a request to exit the zero voltage power management state, the CPU 605 may exit the zero voltage power management state at a higher reference operating voltage. Particularly, under the control of zero voltage entry/exit logic 154 of CPU 605 and zero voltage sleep logic 102 of voltage regulator 612, as previously described, voltage regulator 612 may raise the reference operating voltage 640 to a suitable level such that the CPU 605 may operate properly. The critical state variables of CPU 605 are then restored from the dedicated cache memory 140.

Thus, according to some embodiments of the invention, the power management scheme allows the CPU 605 to save its state information, including warm bit and dirty bit information, turn off the power and then wake up when necessary, restore the state, and continue where the CPU left off. This may be done, in some embodiments, without explicit support from the operating system 645, and may be accomplished with an shorter latency period, due in part to use of the warm and/or dirty bits.

More particularly, in some embodiments of the invention, in the zero voltage processor sleep state, which may be referred to as a C6 state in accordance with ACPI standards, the state of the CPU 605 may be saved in dedicated sleep state SRAM cache 140, which may be powered off the I/O power supply (VI/O) 149, while the core operating voltage 640 for the CPU 605 is taken down to approximately 0 Volts. At this point, the CPU 605. is almost completely powered off and consumes very little power.

Upon an exit event, the CPU 605 may indicate to the voltage regulator 612 to ramp the operating voltage 640 back up (e.g. with a VID code 635), relocks the phase lock loop (PLLS) and turns the clocks back on via clock/power management logic 150 and zero voltage entry/exit logic 154. Further, CPU. 605 may perform an internal RESET to clear states, and may then restore the state of the CPU 605 from the dedicated sleep state SRAM cache 140, and CPU 605 may continue from where it left off in the execution stream. These operations may be done in a very small time period (e.g., approximately 100 microseconds), in CPU 605 hardware, such that it is transparent to the operating system 645 and existing power management software infrastructure.

In some embodiments, this methodology is particularly suited for a CPU 605 having multiple processor cores. In this example, core 120 (e.g. Core #0) and core 122 (e.g. Core #1), i.e. a dual-core CPU, will be discussed as an example. However, it should be appreciated that any suitable number of CPU cores may be utilized. In the dual-core structure, the CPU cores 120 and 122 utilize a shared cache 130. For example, this shared cache 130 may be a level 2 (L2) cache 120 that is shared by the cores 120 and 122.

Further, each core 120 and 122 includes a core ID 121, microcode 123, a shared state 124, and a dedicated state 125. The microcode 123 of the cores 120 and 122 is utilized in performing the save/restore functions of the CPU state and for various data flows in the performance of the zero voltage processor sleep state in conjunction with the zero voltage entry/exit logic 154 of the clock/power management logic 150 of CPU 605. Further, dedicated sleep state SRAM cache 140 may be utilized to save the states of the cores, as well as information related to any warm/dirty bits.

It will be appreciated by one of ordinary skill in the relevant art, based at least on the teachings provided herein, that the system 600 and/or other systems of various embodiments may include other components or elements not shown in FIG. 6 and/or not all of the elements shown in FIG. 6 may be present in systems of all embodiments.

Furthermore, the logic 500 of some embodiments may be implemented as a finite state machine (FSM) within one or more of the components of FIG. 6. One of ordinary skill in the art would appreciate, based at least on the teachings described herein, that such a FSM would operate in accordance with the flowcharts described below.

While many specifics of one or more embodiments have been described above, it will be appreciated that other approaches for optimizing the latency of dynamic memory sizing may be implemented for other embodiments. For example, while specific power states are mentioned above, for other embodiments, other power states and/or other power factors may be considered in determining that memory block contains modified or accessed data. Further, while a memory in a dual core processor in a personal computer is described above for purposes of example, it will be appreciated that an optimized latency approach for dynamic memory sizing, according to one or more embodiments of the invention, may be applied to a different type of memory and/or host integrated circuit chip and/or system.

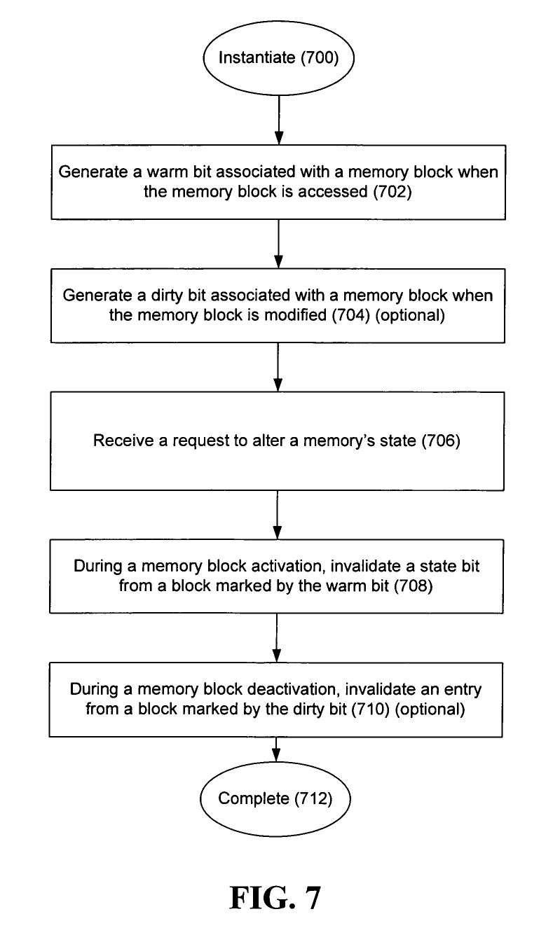

For example, according to various embodiments of the invention, a memory power management logic (not shown, but it may be implemented by at least execution unit 110) or other software or hardware may monitor the work load of a host processor in general and/or of the memory in particular. The memory power management logic may issue a command to effectively shrink the memory depending upon a power state of all or part of the processor or computing system, if the processor is not active for a long period of time, and/or if an application consumes only a small part of the total available memory, for example, and executing one or more of the processes of FIGS. 7-9 described in detail below. This may be done by disabling part of active memory, e.g. one or more ways, as in the example embodiment of FIGS. 1 and/or 2. When the memory power management logic detects that the processor is active for a long time, all or a portion of the processor or host computing system is in a given power state and/or the memory size may not be large enough for the operations required of the processor or computer system, it may issue a command or otherwise control logic to expand the memory by enabling more of the memory, while similarly executing one or more of the processes described in detail below with respect to FIGS. 7-9.

Therefore, according to some embodiments of the invention, a hardware coordination monitor or control logic or PML may iteratively determine when the required number of ways is less than an enabled number of ways and to deactivate (or activate, depending on how the sleep device is configured) the sleep device to disable one or more ways such that the enabled number of ways is substantially equivalent to the required number of ways.

Furthermore, using one or more coherency protocols, according to some embodiments of the invention, the hardware coordination monitor may scan the one or more ways for data to be at least written to a memory.

In another embodiment of the invention, the hardware coordination monitor may also iteratively determine when the required number of ways is more than an enabled number of ways and to activate (or deactivate, depending on how the sleep device is configured) the sleep device to enable one or more ways such that the enabled number of ways is substantially equivalent to the required number of ways.

Embodiments of the present invention may include methods of performing the functions discussed in the foregoing description. For example, an embodiment of the invention may include a method for monitoring a processor and a memory, and adjusting the memory. The process may include additional operations, embodiments of which are described below with respect to FIGS. 7-9.

In these figures are flowcharts which show some embodiments for flows for power state entry and exit using the warm and dirty bits. In some embodiments, the dirty bits may be used during entry to the power state. According to some embodiments of the invention, the dirty bits may at least allow the processor to skip those memory blocks which do not contain modified data. In some embodiments, the warm bits may be used during exit from a power state, such as, but not limited to a particular sleep state. In some embodiments of the invention, the warm bits may at least allow the processor to skip the invalidation of the state bits of the memory blocks that do not contain any data, i.e., that have not been accessed. The usage of warm bits may not be dependent on the power state retaining the state bits in the memory block, i.e., dependent upon a specific level of power to the memory, as the zero voltage logic, which is described elsewhere herein at least with respect to FIG. 6, may allow the processor to maintain the state information even though the processor is essentially sleeping or powered off. In other words, in accordance with some embodiments of the invention, all the state bits may be, but are not necessarily required to be (due to the optional presence of the zero voltage logic or alternatives), invalidated at exit from a power state.

FIG. 7 is a flowchart of an example of a process of optimizing memory latency according to some embodiments of the invention. As described elsewhere herein, the process may be performed in whole or in part by the logic 500, including the decode logic 512, as well as by the power management logic 150 or control logic 154. The process begins at 700 and proceeds to 702 where it generates a warm bit associated with a memory block when the memory block is accessed by the processor. In some embodiments of the invention, the process optionally proceeds to 704 where it generates a dirty bit associated with a memory block when the memory block is modified.

The process then proceeds to 706 where the logic 500, 150 or 154 receives a request to alter a memory's state. In some embodiments of the invention, the request may indicate a change in the power state of one or more of the processor's cores or the processor itself. In some embodiments of the invention, the request may indicate that another device, external to the processor 605, such as, but not limited to the WLAN 661. In some embodiments of the invention, the request may be an indication that the memory is going to be wholly or partially shut down, as described elsewhere herein. As such, the process then proceeds to 708, where it is able to determine from the warm bits which of the memory blocks have been accessed. During a memory block activation, the process may invalidate a state bit from a block marked by a warm bit.

In some embodiments of the invention, the process optionally proceeds to 710, where it is able to determine which memory blocks have been modified from the dirty bits. During a memory block deactivation, the process may invalidate a block marked by a dirty bit. The process then proceeds to 712 where it ends and is able to instantiated again, in whole or in part, as one of ordinary skill would appreciate based at least on the teachings described herein.

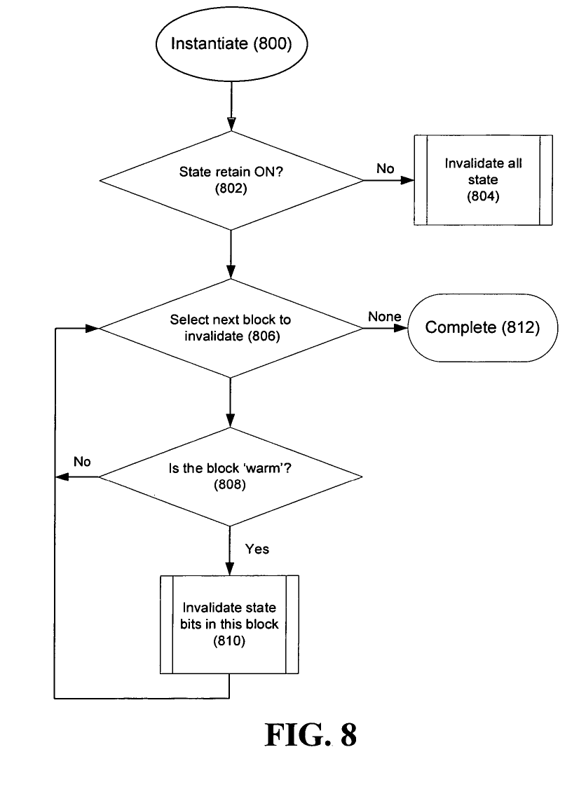

FIG. 8 is a flowchart of an example of a process for memory exit flow according to some embodiments of the invention, as is discussed with respect to one embodiment in FIG. 7 at 708. The process may be performed by the logic 500, 150 or 154, as is described elsewhere herein. The process begins at 800 and proceeds to check to see if any of the state bits are being retained at 802. If not, the process proceeds to 804 and may invalidate all state bits. If so, the process then proceeds to 806.

At 806, the process may select a next block to invalidate. If there are not other blocks to select, the process may proceed to 812 and end, where it may be able to be instantiated again, in whole or in part, as one of ordinary skill would appreciate based at least on the teachings described herein. If so, the process may proceed to 808.

At 808, the process may check if the block is marked by a warm bit. If so, the process may then invalidate the state bits for this block at 810. If not, the process may proceed back to 806. In some embodiments, after 810, the process proceeds back to 806.

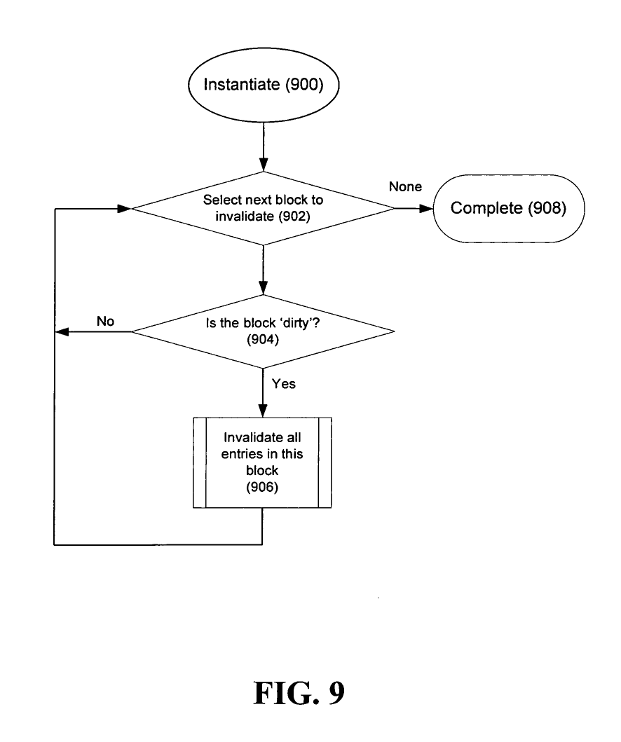

FIG. 9 is a flowchart of an example of a process for memory entry flow according to some embodiments of the invention, as is discussed with respect to one embodiment in FIG. 7 at 710. The process may be performed by the logic 500, 150 or 154, as is described elsewhere herein. The process begins at 900 and proceeds to select a next block to invalidate at 902. If there are no other blocks to invalidate, the process completes itself at 908, where it may be able to be instantiated again, in whole or in part, as one of ordinary skill would appreciate based at least on the teachings described herein. If so, the process may proceed to 904.

At 904, the process check if the block is marked by a dirty bit. If so, the process may then proceed to invalidate all entries in this block at 906. If not, the process may proceed back to 902. In some embodiments, the process proceeds back to 902 after 906.

Any reference in this specification to “one embodiment,” “an embodiment,” “some embodiments,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering or simultaneously, as one or ordinary skill would appreciate based at least on the teachings provided herein.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Accordingly, the detailed description is not to be taken in a limiting sense.

The foregoing embodiments and advantages are merely exemplary and are not to be construed as limiting the present invention. For instance, the present teaching can be readily applied to other types of memories. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A system comprising:
a memory including a plurality of blocks, wherein each block includes at least one way;
a logic to generate either a warm bit or a dirty bit, wherein the warm bit indicates that at least one block of the plurality of blocks was accessed, and wherein the dirty bit indicates that at least one block of the plurality of blocks was modified;
a control logic to request a change in power state; and
a processor to request the memory to activate another block of the plurality of blocks, wherein the warm bit indicates the necessity of invalidating a state bit.

2. The system of claim 1, wherein the logic is adapted to generate at least one warm bit for each dirty bit.

3. The system of claim 1, wherein the processor is adapted to request the memory to deactivate an activated block of the plurality of the blocks, and wherein the dirty bit indicates the necessity of invalidating an entry from the activated block.

4. The system of claim 1, wherein the at least one way includes more than one block of memory.

5. The system of claim 1, wherein the logic is adapted to operate on at least one of a power management logic, the control logic, or an operating system.

6. The system of claim 1, wherein the memory is a synchronous random access memory internal to a package containing the processor.

7. The system of claim 1, wherein the processor includes at least a first core and a second core.

8. The system of claim 7, wherein the first core has a first unique identifier and the second core has a second unique identifier and the memory restores the state variables of a particular core based on the unique identifier of that particular core.

9. The system of claim 1, further comprising:
a wireless local area network (WLAN) module for receiving and transmitting information to and from the system.

10. A memory device comprising:
a memory including a plurality of blocks, wherein each block includes at least one way; and
a logic to generate either a warm bit or a dirty bit, wherein the warm bit indicates that at least one block of the plurality of blocks was accessed, and wherein the dirty bit indicates that at least one block of the plurality of blocks was modified.

11. The memory device of claim 10, wherein the logic is adapted to generate at least one warm bit for each dirty bit.

12. The memory device of claim 10, wherein the logic is adapted to receive instructions from a processor and/or control logic.

13. The memory device of claim 10, wherein the memory is a synchronous random access memory.

14. A method comprising:
generating either a warm bit or a dirty bit, wherein the bits are associated with a block of memory, wherein the warm bit indicates that the block of memory has been accessed, and wherein the dirty bit indicates that the block of memory has been modified;
receiving a request to altering a memory's state; and
invalidating a state bit from the block of memory marked by the warm bit.

15. The method of claim 14, further comprising:
after receipt of the request to alter the memory's state, invalidating an entry from the block of memory marked by the dirty bit.

16. The method of claim 14, wherein the warm bit is derived from at least one of a memory transaction address, a way select, a write enable, or a transaction type information.

17. The method of claim 15, wherein the warm bit is derived from at least one of a memory transaction address, a way select, a write enable, or a transaction type information.

18. The method of claim 14, wherein the request results as part of a transition from one power state to another power state.

19. The method of claim 14, wherein the invalidating the state bit comprises:
checking whether the state bit was retained and invalidating all states if the state bit was not retained;
selecting the block of memory to invalidate;
determining whether the block of memory is marked by a warm bit; and
invalidating the state bit from the block of memory.

20. The method of claim 15, wherein the invalidating the entry comprises:
selecting the block of memory to invalidate;
determining whether the block of memory is marked by a dirty bit; and
invalidating the entry from the block of memory.

21. The method of claim 14, further comprising:
clearing the warm bit.

22. The method of claim 14, further comprising:
clearing the dirty bit.

23. A machine-readable medium having stored thereon instructions, which when executed by a machine, cause the machine to perform operations comprising:
generating either a warm bit or a dirty bit, wherein the bits are associated with a block of memory, wherein the warm bit indicates that the block of memory has been accessed, and wherein the dirty bit indicates that the block of memory has been modified;
receiving a request to altering a memory's state; and
invalidating a state bit from the block of memory marked by the warm bit.

24. The machine-readable medium of claim 23, further comprising:
after receipt of the request to alter the memory's state, invalidating an entry from the block of memory marked by the dirty bit.

25. The machine-readable medium of claim 23, wherein the warm bit is derived from at least one of a memory transaction address, a way select, a write enable, or a transaction type information.

26. The machine-readable medium of claim 24, wherein the warm bit is derived from at least one of a memory transaction address, a way select, a write enable, or a transaction type information.

27. The machine-readable medium of claim 23, wherein the request results as part of a transition from one power state to another power state.

28. The machine-readable medium of claim 23, wherein the invalidating the state bit comprises:
checking whether the state bit was retained and invalidating all states if the state bit was not retained;
selecting the block of memory to invalidate;
determining whether the block of memory is marked by a warm bit; and
invalidating the state bit from the block of memory.

29. The machine-readable medium of claim 24, wherein the invalidating the entry comprises:
selecting the block of memory to invalidate;
determining whether the block of memory is marked by a dirty bit; and
invalidating the entry from the block of memory.

30. The machine-readable medium of claim 23, further comprising:
clearing the warm bit.

31. The machine-readable medium of claim 23, further comprising:
clearing the dirty bit.
